(19) United States
(12) Patent Application Publication
(10) Pub. No.: US 2018/0121393 A1
(43) Pub. Date: May 3, 2018

(54) TEXT OUTPUT COMMANDS SEQUENCING FOR PDF DOCUMENTS

(71) Applicant: ABBYY Development LLC, Moscow (RU)

(72) Inventor: Anton Andreevich Masalovitch, Moscow (RU)

(21) Appl. No.: 15/369,103

(22) Filed: Dec. 5, 2016

(30) Foreign Application Priority Data
Nov. 1, 2016 (RU) 2016142903

(51) Int. Cl. G06F 17/21; G06F 17/27; G06F 17/22

(52) U.S. Cl. CPC G06F 17/211; G06F 17/2765; G06F 17/2247; G06F 17/218; G06F 17/2241

(57) ABSTRACT

A document is received with a plurality of text output commands in a text layer, where each text output command is to render one or more glyphs on a display device. A set of text output commands are identified in the text layer for a page of a plurality of pages of the document. The logical structure of the page of the document is determined, and ordered sequence of a set of text output commands for the page is determined, where the ordered sequence reflects the reading order within each of a plurality of blocks of content for the page. A modified text layer is generated for the document with the set of output commands in the ordered sequence. The modified text layer is then provided to cause a display device to render a plurality of glyphs corresponding to the set of text output commands in the ordered sequence.

### CROSS REFERENCE TO RELATED APPLICATIONS

The present application claims the benefit of priority under 35 USC 119 to Russian Patent Application No. 2016142903, filed Nov. 1, 2016; the disclosure of which is incorporated herein by reference in its entirety for all purposes.

### TECHNICAL FIELD

The present disclosure is generally related to computer systems, and is more specifically related to systems and methods for sequencing text output commands in documents.

### BACKGROUND

Portable Document Format (PDF) is a format used to present documents in a manner independent of application software, hardware, or operating systems. A PDF document can encapsulate a complete description of a fixed-layout document, including the text, fonts, graphics, and other information for displaying it. A PDF document can include a text layer that is comprised of text output commands for rendering glyphs when displaying the document.

### SUMMARY

Embodiments of the present disclosure describe smart text output command sequencing for logical blocks of PDF documents. A document is received that includes a plurality of text output commands in a text layer, where each text output command is to render one or more glyphs on a display device. Using the plurality of text output commands in the text layer, a set of text output commands are identified for a page of a plurality of pages of the document. The logical structure of the page of the document is determined, where the logical structure comprises a plurality of blocks of content that cause an order of the set of text output commands in the text layer to differ from a reading order of the page of the document. An ordered sequence of a set of text output commands for the page is determined, where the ordered sequence reflects the reading order within each of a plurality of blocks of content for the page. A modified text layer is generated for the document with the set of output commands in the ordered sequence. The modified text layer is then provided to cause a display device to render a plurality of glyphs corresponding to the set of text output commands in the ordered sequence.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level diagram of an example smart document generator, in accordance with one or more aspects of the present disclosure.

FIG. 2A depicts a block diagrams of an example of generating an ordered sequence of a set of text output commands for a page of a document, in accordance with one or more aspects of the present disclosure.

FIG. 2B depicts a block diagrams of an example of generating an ordered sequence of a set of text output commands for a page of a document, in accordance with one or more aspects of the present disclosure.

FIG. 2C depicts an example of modified text blocks with text output commands in an ordered sequence, in accordance with one or more aspects of the present disclosure

FIG. 3 depicts a flow diagram of a method for smart text output command sequencing, in accordance with one or more aspects of the present disclosure.

FIG. 4 depicts a flow diagram of a method for determining the logical structure of a page of a document, in accordance with one or more aspects of the present disclosure.

FIG. 5 depicts a flow diagram of a method for determining an ordered sequence of text output commands for a page of a document, in accordance with one or more aspects of the present disclosure.

FIG. 6 depicts a flow diagram of a method for sorting text output commands into reading order for horizontal text, in accordance with one or more aspects of the present disclosure.

FIG. 7 depicts a flow diagram of a method for sorting text output commands into reading order for vertical text, in accordance with one or more aspects of the present disclosure.

FIG. 8 depicts a block diagram of an illustrative computer system operating in accordance with examples of the present disclosure.

### DETAILED DESCRIPTION

Described herein are methods and systems for smart text output command sequencing for logical blocks of PDF documents. PDF documents that include a text layer can be arranged so that the order of the text output commands in the document may be different from the order that the corresponding text is displayed on a display device, and subsequently read by a user (also referred to as the “reading order”). For example, in a Searchable PDF, which is a bitmap image with an invisible text layer, each letter may be part of a raster image and associated with a particular character within the text layer. In some cases, the letters that follow each other in the image may not follow each other in the text layer. So, while the text may be displayed correctly, utilizing the text in the text layer (selecting, copying, etc.) can prove difficult. This can be particularly problematic with documents that include multiple columns of text on a page. For example, when using a cursor to select the lines in a column of text, when selecting a specific line of text within the column, the cursor may suddenly jump not to the next line in the column, but to a line in a different column on the page. Additionally, when copying text from the PDF document into another document, the order of lines of text (and sometimes the order of words or characters) can be arbitrary. This can result in extensive manual intervention on the part of a user to correct the order of text as it is copied from a PDF document to another document.

Aspects of the present disclosure address the above noted and other deficiencies by analyzing the logical structure of a PDF document to identify blocks of text within a page, and resequencing the text output commands in the text layer to reflect the reading order of the text for the page within each block of text. In an illustrative example, a PDF document is received that includes a plurality of text output commands in a text layer, where each text output command is to render one or more glyphs on a display device. A set of text output commands are identified in the text layer for a page of a plurality of pages of the document. The logical structure of the page of the document is determined, and ordered sequence of a set of text output commands for the page is determined, where the ordered sequence reflects the reading order within each of a plurality of blocks of content for the page. A modified text layer is generated for the document with the set of output commands in the ordered sequence. The modified text layer is then provided to cause a display device to render a plurality of glyphs corresponding to the set of text output commands in the ordered sequence.

Aspects of the present disclosure are thus capable of more efficiently organizing a PDF document text layer to reflect the reading order of the text within each page of the document. The resulting text layer can thus be more efficiently and effectively utilized without requiring extensive manual editing, thereby reducing or eliminating the resources needed for document creation and/or modification. Particularly, when using a cursor to select the lines in a column of text, the text may be selected in the reading order for the selection. Moreover, when copying text from the PDF document into another document, the order of lines of text (and the order of words or characters within the lines) can be copied to reflect the reading order of the text.

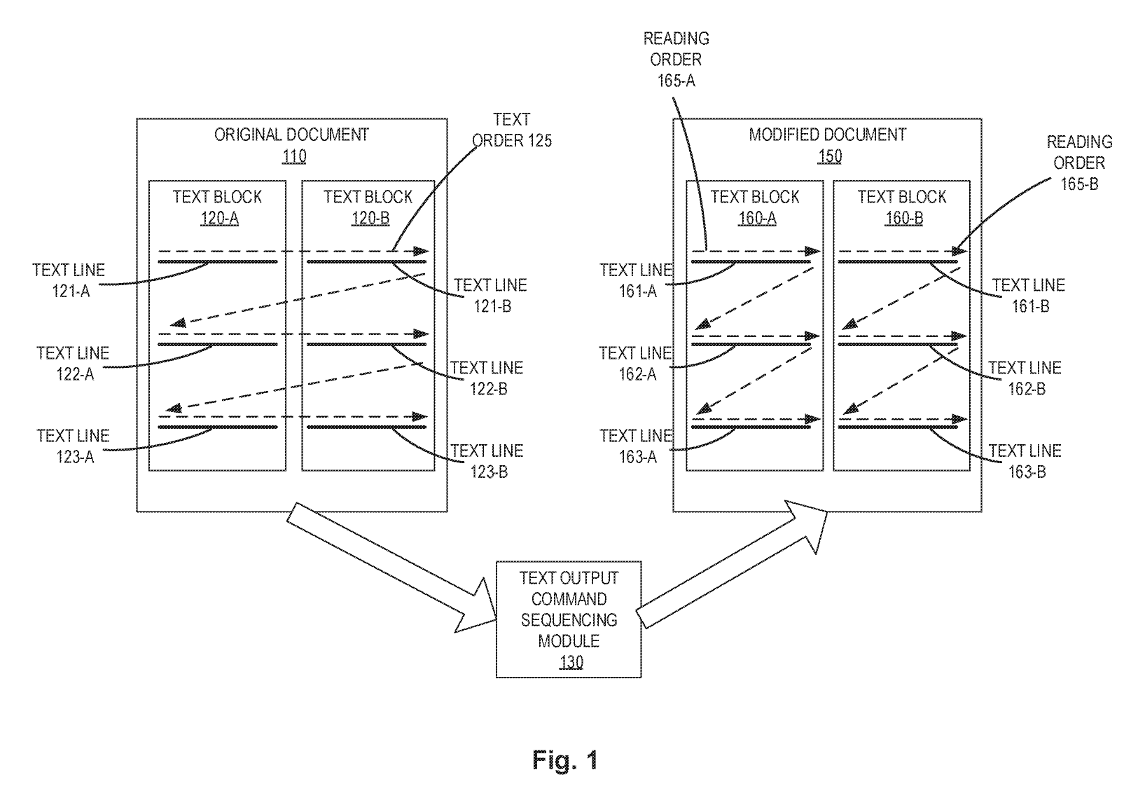

FIG. 1 depicts a high-level component diagram of an example smart text output command sequencing system in accordance with one or more aspects of the present disclosure. The smart text output command sequencing system may include a text output command sequencing module 130 that may be a client-based application or may be a combination of a client component and a server component. In some implementations, the text output command sequencing module 130 may execute entirely on the client computing device such as a tablet computer, a smart phone, a notebook computer, a camera, a video camera, or the like. Alternatively, the text output command sequencing module 130 executing on the client computing device may receive a document and transmit it to the server component of the text output command sequencing module 130 executing on a server device that performs the text output command sequencing. The server component of the text output command sequencing module 130 may then return a modified document to the client component of the text output command sequencing module 130 executing on the client computing device. In other implementations, text output command sequencing module 130 may execute on a server device as an Internet-enabled application accessible via a browser interface. The server device may be represented by one or more computer systems such as one or more server machines, workstations, mainframe machines, personal computers (PCs), etc. In some implementations, the text output command sequencing module 130 may be a component of a document management system that may open, display, and/or store documents.

In an illustrative example, the text output command sequencing module 130 can receive an original document 110. In some implementations, the original document 110 may be a portable document format (PDF) document that includes text output commands in a text layer of the document where each text output command is to render one or more glyphs on a display device. Original document 110 may be a digitally created PDF document (e.g., a “True PDF”), a searchable PDF document, or any other document that includes a text layer. A searchable PDF document may be generated through the application of OCR (Optical Character Recognition) to scanned PDFs or other image-based documents. During the text recognition process, characters and the document structure of the image are analyzed, and a text layer may then be added to the document image, usually placed beneath the image layer.

As noted above, the text layer can include text output commands to render glyphs when the document is displayed. A text output command can include information describing how text may be displayed such as a font typeface for the text, a font size for the text, a document page on which to display the text, a coordinate location on the document page to display the text, one or more characters to be displayed, color properties of the text, or other similar rendering properties. Text output command sequencing module 130 may identify, using the text output commands in the text layer, a set of text output commands for a single page out of a plurality of pages of the document.

Text output command sequencing module 130 may then determine a logical structure of the single page of document 110. Original document 110 may have a logical structure that includes multiple pages, and any of the pages may include multiple blocks of content. The blocks of content may include blocks of text, images, tables, or any other type of content. As shown in FIG. 1, original document 110 can include text blocks 120-A and 120-B, that each include lines of text (Text lines 121-A through 123-A, and text lines 121-B through 123-B respectively). Text block 120-A and 120-B may be two columns of text on the page of original document 110, such as that which would be displayed in a printed publication (e.g., a news article, magazine, article, or the like). It should be noted that, for simplicity, original document 110 is shown in FIG. 1 as a single page with two text blocks that each contain three lines of text, in other implementations, original document 110 may include more than one page with more or fewer blocks of content, each block containing more or fewer lines of text than that depicted in FIG. 1.

Text output command sequencing module 130 may determine the logical structure by analyzing the meta-data in a True PDF. Alternatively, text output command sequencing module 130 may determine the logical structure by analyzing the document as an image. Text output command sequencing module 130 may receive an image of the page of the document (e.g., in a searchable PDF, where there is an image layer present in the document). Text output command sequencing module 130 may identify the blocks of content in the image of the page, determine location coordinates and/or boundary areas of each of the blocks of content on the page, and determine an orientation of the text (e.g., horizontally flowing text, vertically flowing text, etc.) in the image for the blocks of content.

In some implementations, the logical structure of the page may include blocks of content that cause an order of the set of text output commands in the text layer (e.g., text order 125) to differ from a reading order of the page. The reading order should indicate the order in which the text would be read by a reader, as opposed to the order in which the text lines appear on the page of original document 110. As shown in FIG. 1, text lines 121-A and 121-B are displayed on the same line of the page, but text line 121-B would not be read by a reader immediately after text line 121-B, since the two lines are in different columns (e.g., text blocks 120-A and 120-B respectively). In the text layer for the page, the text output commands for the glyphs in text line 121-A appear first, followed by the text output commands for the glyphs in text line 121-B, text line 122-A, 122-B, 123-A, and 123-B respectively (following the order of text order 125). The presence of the two identified text blocks (120-A, 120-B), indicate that the text output commands for the text lines on the page should be ordered within each block, rather than across the page.

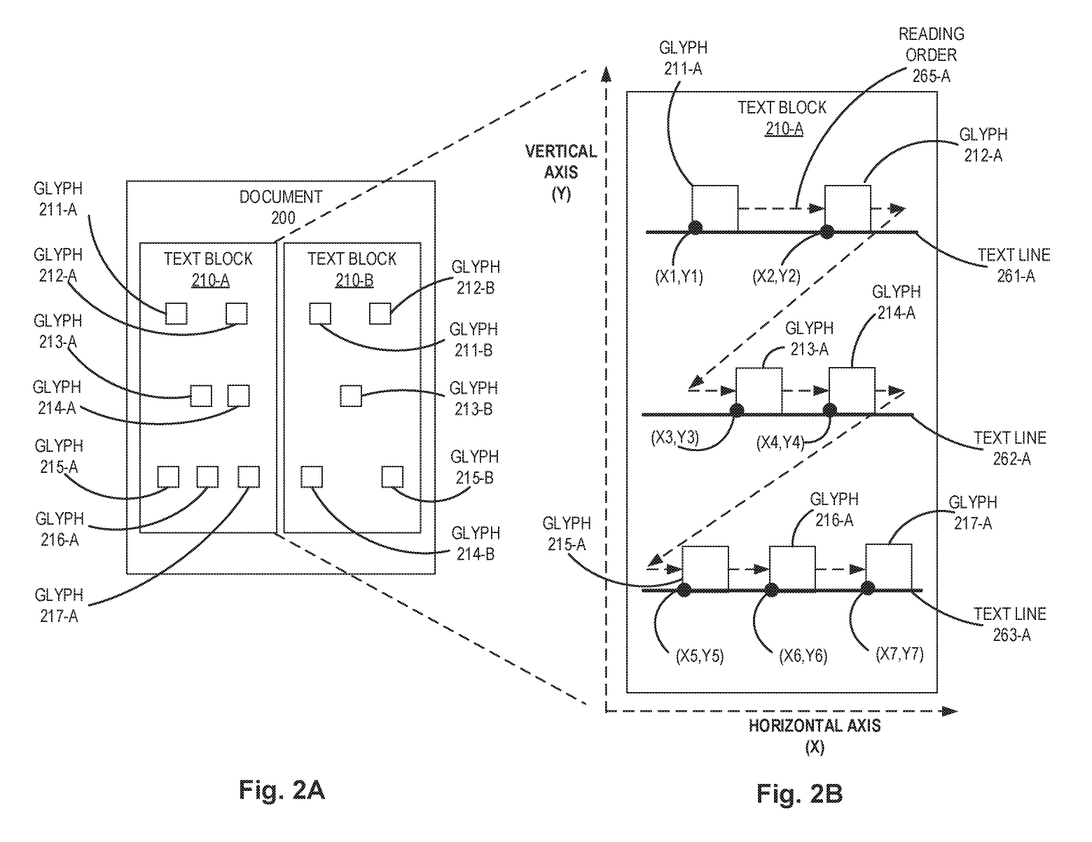

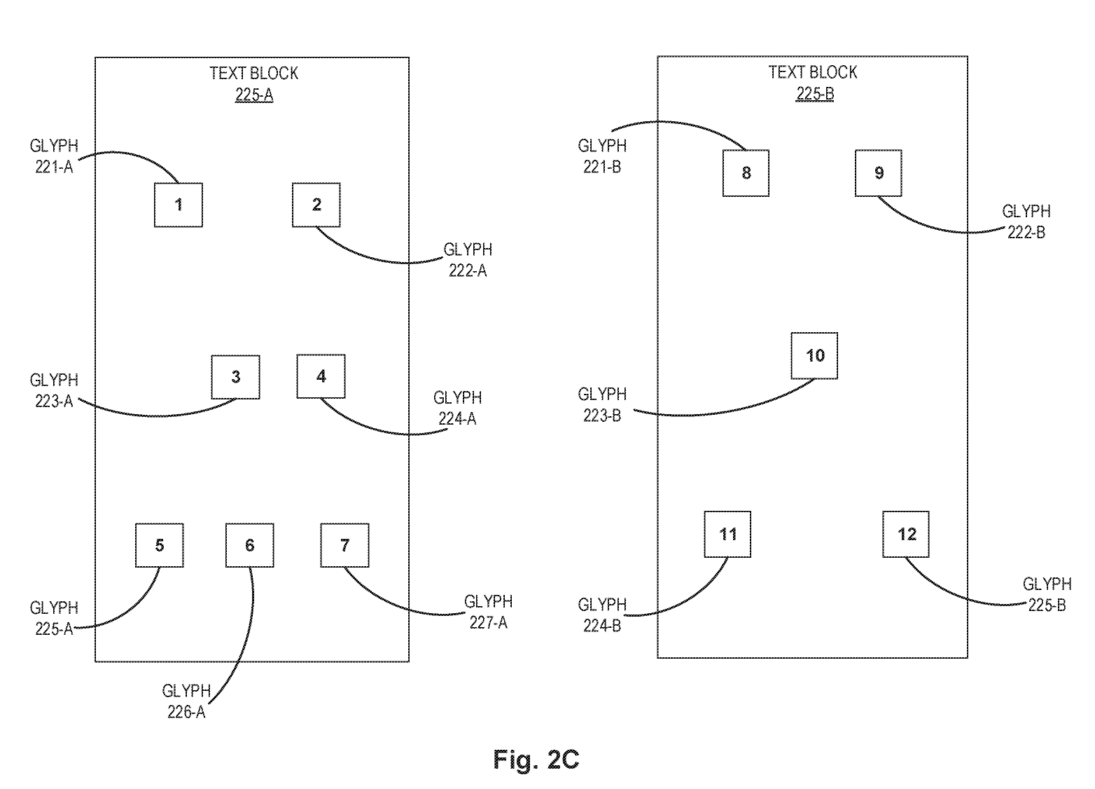

Text output command sequencing module 130 may then determine an ordered sequence of the set of text output commands for the page, where the ordered sequence reflects the reading order within each of the blocks of content. For example, a reading order of the column of text for text block 120-A should indicate the order in which the text could be read by a reader. Meaning, the text output commands for the glyphs in text line 121-A should be first, followed by the text output commands for the glyphs in text line 122-A, then by the text output commands for the glyphs in text line 123-A. The text output commands for the glyphs in text lines 121-B through 123-B in text block 120-B should then follow the text output commands for text block 120-A in the text layer for the document. In some implementations, text output command sequencing module 130 may generate the ordered sequence of the set of text output commands for the page as described below with respect to FIGS. 2A, 2B, and 2C.

Subsequently, text output command sequencing module 130 may generate a modified text layer for the document page where the modified text layer includes the set of text output commands in the ordered sequence. As shown in FIG. 1, text output command sequencing module 130 may generate a modified text layer depicted in modified document 150 where the text output commands for the glyphs in text lines 161-A through 163-A are stored in reading order 165-A (the reading order for text block 160-A), followed by the text output commands for the glyphs in text lines 161-B through 163-B in reading order 165-B (the reading order for text block 160-B).

Text output command sequencing module 130 may then provide the modified text layer to cause the display device to render the glyphs for the glyphs corresponding to the set of text output commands for the page in the ordered sequence. In some implementations, text output command sequencing module 130 may complete the above process for a single page being displayed. Alternatively, text output command sequencing module 130 may complete the process for each page in the document before displaying any of the pages. Text output command sequencing module 130 may then store a modified document with the modified text layer. Alternatively, the modified text layer may be temporarily maintained by the system (e.g., in device memory or other temporary storage) and subsequently discarded without storing a modified document.

FIGS. 2A-2C depict block diagrams of an example of generating an ordered sequence of a set of text output commands for a page of a document 200, in accordance with one or more aspects of the present disclosure. In some implementations, document 200 corresponds to original document 100 of FIG. 1. As shown in FIG. 2A, the page of document 200 may have a logical structure that includes two text blocks (text blocks 210-A, 210-B) that each include several lines of text to be displayed. As described above with respect to FIG. 1, the text output commands in the text layer of the page of document 200 differ from the reading order of the page.

To determine the ordered sequence for the set of text output commands for the page, a text output command sequencing module (such as Text output command sequencing module 130 of FIG. 1) may select one of the blocks of content for the page. The text output command sequencing module may select the block based on the logical structure of the page as described above. For example, for text organized in columns of text oriented horizontally, the text output command sequencing module may select the text block that begins in the upper left of the page. Once the text output commands for that text block have been analyzed and ordered, text output command sequencing module may then search vertically down the page to find the next text block. If none are found, the text output command sequencing module may then search for the next text block starting at the top of the page, moving horizontally across the page, and so on.

Once a text block has been identified and selected, the text output command sequencing module may then determine a boundary area of the text block based on the location coordinates of the text block identified in the logical structure of the page. The boundary areas of text blocks 210-A and 210-B are depicted in FIG. 2A as boxes surrounding the glyphs 211-A through 217-A and 211-B through 214-B respectively. The text output command sequencing module may then identify a subset of the text output commands for the page that are located within the boundary area of the block. Thus, for text block 210-A, the text output command sequencing module can identify the subset of text output commands that render glyphs 211-A through 217-A. The subset may be identified by comparing the coordinate values of the boundary area of text block 210-A to the coordinate values of the text output commands in the text layer for the page. If the coordinate value for a text output command is located within the boundary of text block 210-A, the text output command sequencing module may identify the text output command as part of the set for that block.

The text output command sequencing module may then sort the subset of text output commands for text block 210-A into a reading order of the text output commands within the boundary area of the block. In some implementations, the text output command sequencing module may first order the subset of text output commands in to lines of text output commands based on the coordinate values for the individual commands in the subset. The text output command sequencing module may then order the text output commands for each line in the reading order for the line based on the coordinate values. FIG. 2B illustrates the text output commands for text block 210-A sorted into a reading order 265-A within the boundary area of the block.

In an illustrative example, where the orientation of the text in text block 210-A is horizontal as depicted in FIGS. 2A-2B, the text output command sequencing module may first sort the subset of text output commands for text block 210-A by vertical axis coordinate value. As noted above, each of the text output commands in the text layer can include a location coordinate of the first glyph that is to be rendered by the text output command. This can be stored as an (X,Y) coordinate for a horizontal and vertical two-dimensional plan (e.g., as shown in FIG. 2B), as an offset within the page, or in any similar manner. The text output command sequencing module identifies the text output command with a vertical axis coordinate value that indicates it is near the top the text block (e.g., the largest vertical axis (Y) coordinate value for the block), then identifies the next text output command in the sorted list (text output command for glyph 211-A at (X1,Y1) and text output command for glyph 212-A at (X2,Y2) as shown in FIGS. 2A-2B).

The text output command sequencing module then determines the difference between the vertical axis coordinate for the first text output command and the second text output command (e.g., the difference between Y1 and Y2 in FIG. 2B). Responsive to determining that the difference is less than or equal to a threshold value, the text output command sequencing module can assign the two text output commands to the same line of text. As shown in FIG. 2B, the difference between Y1 and Y2 are within the threshold, so the text output commands for glyphs 211-A and 212-A can be assigned to the same line of text (text line 261-A). Responsive to determining that the difference is greater than the threshold, the text output command sequencing module can assign the two text output commands to different lines of text. For example the vertical coordinates of the text output commands for glyphs 211-A (Y1) and 213-A (Y3) (or 212-A (Y2) and 213-A (Y3)) may exceed the threshold, and may thus be assigned to separate lines of text as shown in FIG. 2B. The process may proceed through the sorted list until each of the text output commands has been assigned to a horizontal line of text.

Thus, as shown in FIG. 2B, text block 210-A includes three lines of text, each represented by text output commands in the text layer of the page of document 200. The first line of text (text line 261-A) is represented by text output commands to render glyphs 211-A and 212-A, the second line (text line 262-A) is represented by text output commands to render glyphs 213-A and 214-A, and the third line (text line 263-A) is represented by text output commands to render glyphs 215-A, 216-A, and 217-A. As described above, the text output commands to render the glyphs in the three lines may then be arranged in reading order 265-A. The process may be repeated for text block 210-B to determine that text block 210-B includes three lines of text, the first line represented by text output commands to render glyphs 211-B and 212-B, the second line represented by a text output command to render glyph 213-B, and the third line represented by text output commands to render glyphs 214-B, and 215-B. The glyphs for these lines may similarly be arranged in a reading order for text block 210-B. Moreover, the process can determine the reading order for the page of document 200 such that the reading order for 210-B follows the reading order for block 210-A. Thus, if a user selects the text from block 210-A and drags a cursor using a user interface across the page, the text corresponding to the glyphs in block 210-A may be selected first, followed by the text corresponding the glyphs in text block 210-B

Similarly, where the orientation of the text is vertical (e.g., vertical lines of Asian characters), the text output command sequencing module may first sort the subset of text output commands for a text block by horizontal axis (X) coordinate value. The text output command sequencing module identifies the text output command with a horizontal axis coordinate value that indicates it is near the left the text block (e.g., the smallest horizontal axis (X) coordinate value for the block), then identifies the next text output command in the sorted list. The text output command sequencing module then determines the difference between the horizontal axis coordinate for the first text output command and the second text output command (e.g., the difference between the X coordinate values). Responsive to determining that the difference is less than or equal to a threshold value, the text output command sequencing module can assign the two text output commands to the same line of text. Responsive to determining that the difference is greater than the threshold, the text output command sequencing module can assign the two text output commands to different lines of text. The process may proceed through the sorted list until each of the text output commands has been assigned to a vertical line of text.

Once the text output commands have been assigned to lines based on the vertical axis coordinate value, they may then be sorted into reading order. In some implementations, the text output commands may be sorted within each line by to obtain the reading order for the line. Text that has a uniform horizontal direction from left to right (e.g., English, Russian, etc.) may be sorted in ascending order by horizontal axis coordinate (X) value. Text that has a uniform horizontal direction from right to left (e.g., Arabic, Hebrew, etc.) may be sorted in descending order by horizontal axis coordinate (X) value. Text that has a uniform vertical direction from top to bottom (e.g., Asian languages such as Chinese, Japanese, and Korean) may be sorted in descending order by vertical axis coordinate (Y) value. Text that has a uniform vertical direction from bottom to top may be sorted in ascending order by vertical axis coordinate (Y) value. As shown in FIG. 2B, the reading order 265-A for text block 210-A results in the text commands as follows: 211-A (X1,Y1), 212-A (X2,Y2), 213-A (X3,Y3), 214-A (X4,Y4), 215-A (X5,Y5), 216-A (X6,Y6), and 217-A (X7,Y7).

In some implementations, lines of text may include some portions of the line that are oriented in one direction and other portions that are oriented in the opposite direction. For example, a single line of horizontal text may include text in English (directed from left to right) as well as Arabic (directed from right to left). In such cases, the text output command sequencing module may first identify characteristics of the portions of the text to determine the direction of the different portions. This information may be included in the text output commands associated with the glyphs, may be determined during optical character recognition processing, by implementing an algorithm to determine the directionality for bidirectional Unicode text of the different portions of the text line, or in any other manner. Once the directions of the different portions of a line of text are identified, the text commands for the different portions of the line may be sorted according to the corresponding direction.

For example, once the text output commands have been assigned to a line, and one portion of the text output commands for that line are for English characters and another portion of the text output commands for that line are for Arabic characters, the text output command sequencing module may use the process described above to sort the portions of text according to their direction to determine the reading order for the line. Thus, the text output commands for the English text can be sorted in ascending order by horizontal axis coordinate (X) value, and the text output commands for the Arabic characters may be sorted in descending order by horizontal axis coordinate (X) value. A similar process may be used for vertically oriented text where one portion of a vertical line of text is directed from top to bottom and another portion of that line of text is directed from bottom to top.

Subsequently, the text output command sequencing module may generate an ordered sequence number for each text output command of the subset of output commands for the block, where each ordered sequence number reflects the position of the corresponding text output command in the reading order for the block. The ordered sequence number may generated using numeric characters, alphabetic characters, alpha-numeric characters, or in any similar manner that indicates a sequential order. In an illustrative example, the ordered sequence numbers for the text output commands for text block 210-A in the reading order 265-A for the block may be as follows: 211-A (1), 212-A (2), 213-A (3), 214-A (4), 215-A (5), 216-A (6), and 217-A (7).

The text output command sequencing module may repeat the above process for each block of content on the page of document 200. As shown in FIG. 2A, text block 210-B may be selected, and its boundary area determined based on its coordinate location within the page. A second subset of text output commands for the page that are located within the boundary area of block 210-B may be identified based on the coordinate values of the text output commands. The second subset of text output commands for text block 210-B may then be sorted into a reading order within the boundary area for the block (first into lines, then within each line). In an illustrative example, the reading order for text block 210-B may result in the text commands for the glyphs as follows: 211-B, 212-B, 213-B, 214-B, and 215-B.

Additional ordered sequence numbers may then be generated for each of the text output commands for text block 210-B. In some implementations, the ordered sequence numbers for the text output commands of text block 210-A may precede the additional ordered sequence numbers for text output commands of block 210-B in the ordered sequence for the page. Thus, the ordered sequence numbers for the text output commands for text block 210-B in the reading order for the block may be as follows: 211-B (8), 212-B (9), 213-B (10), 214-B (11), and 215-B (12). A modified text layer for the document page may then be generated with the text output commands for blocks 210-A and 210-B in the ordered sequence may then be generated.

FIG. 2C illustrates an example of text blocks 225-A and 225-B that may correspond to the modified text layer for text blocks 210-A and 210B of FIG. 2A. As shown in FIG. 2C, the text output commands of text block 225-A (for glyphs 221-A, 222-A, 223-A, 224-A, 225-A, 226-A, and 227-A) have been assigned ordered sequence numbers to reflect the reading order of block 225-A. Similarly, the text output commands of text block 225-B (for glyphs 221-B, 222-B, 223-B, 224-B, and 225-B) have been assigned ordered sequence numbers to reflect the reading order of block 225-B. The ordered sequence numbers for the text output commands of text block 225-A (1, 2, 3, 4, 5, 6, and 7) precede the ordered sequence numbers for the text output commands of text block 225-B (8, 9, 10, 11, and 12), which reflects the overall reading order for the page of the document in the modified text layer.

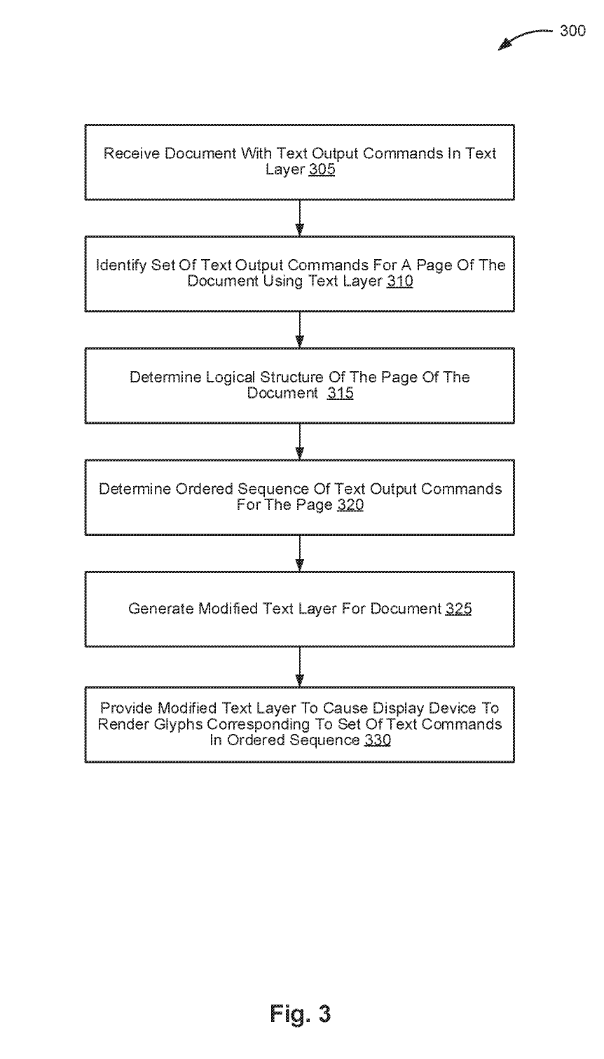

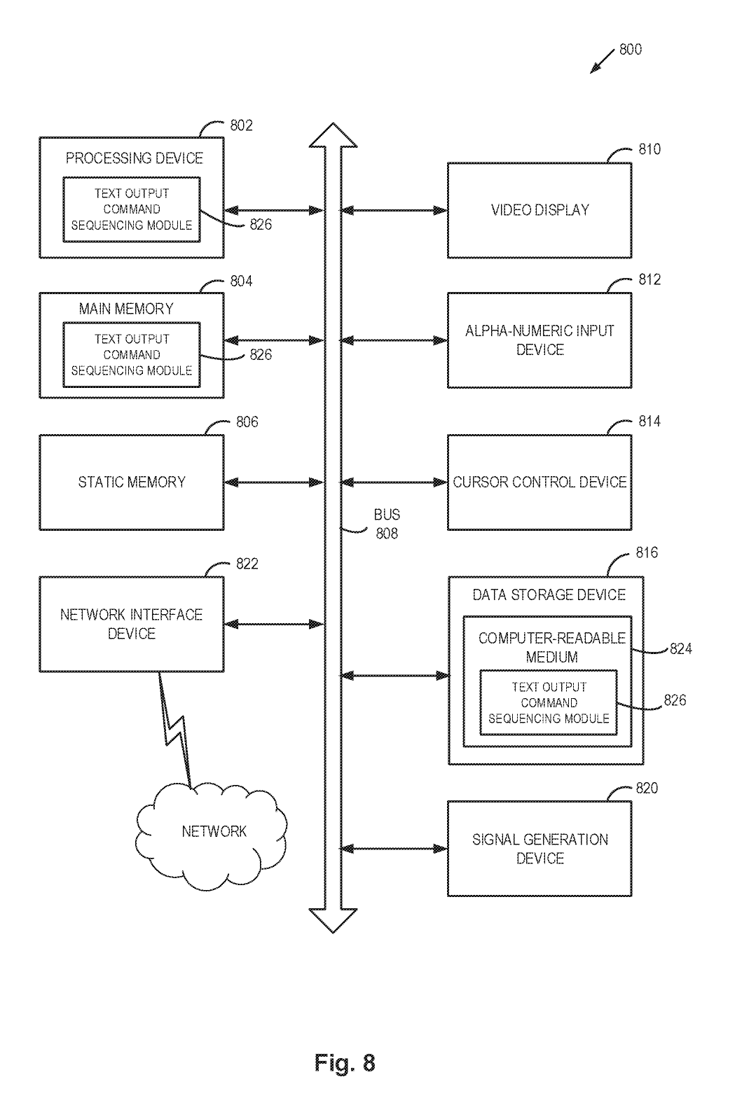

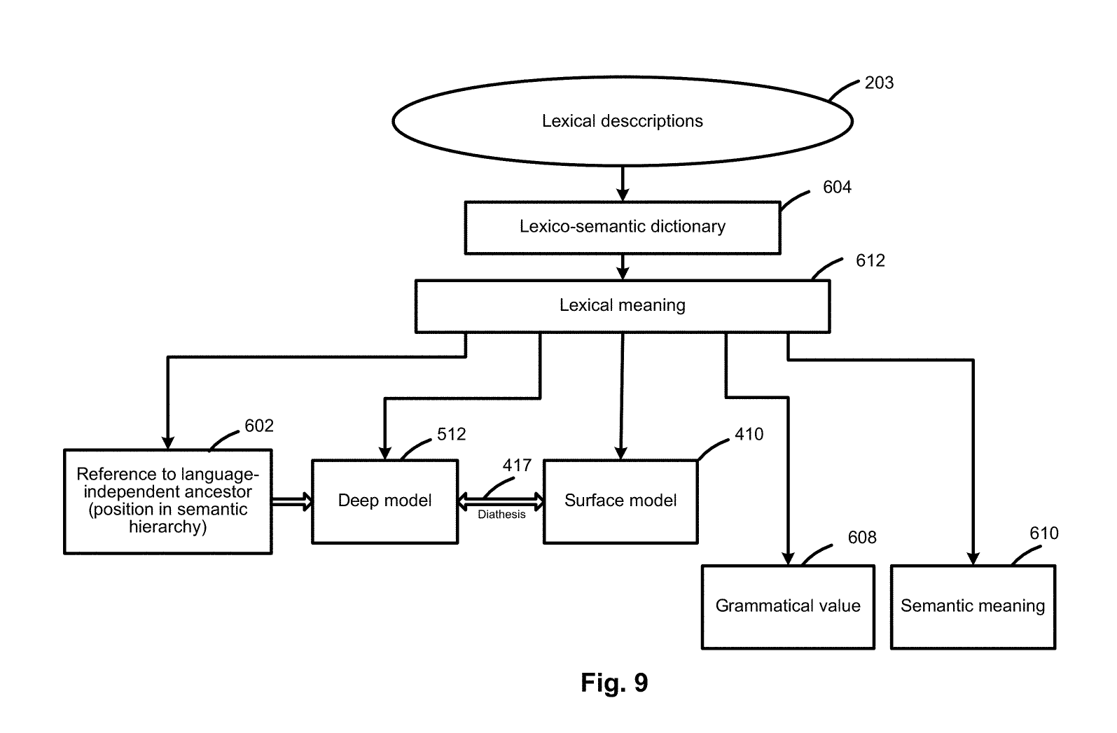

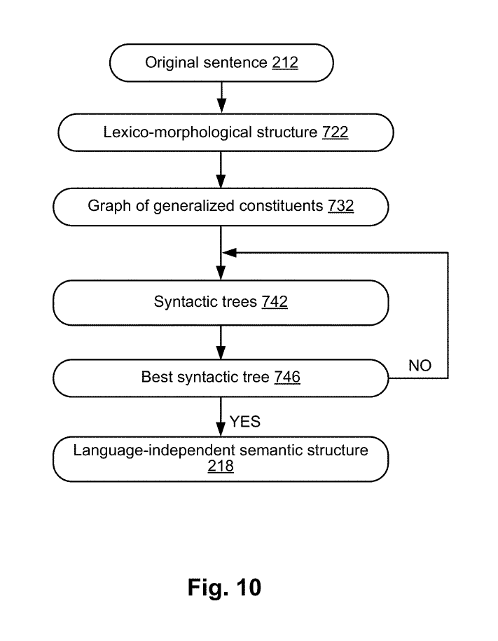

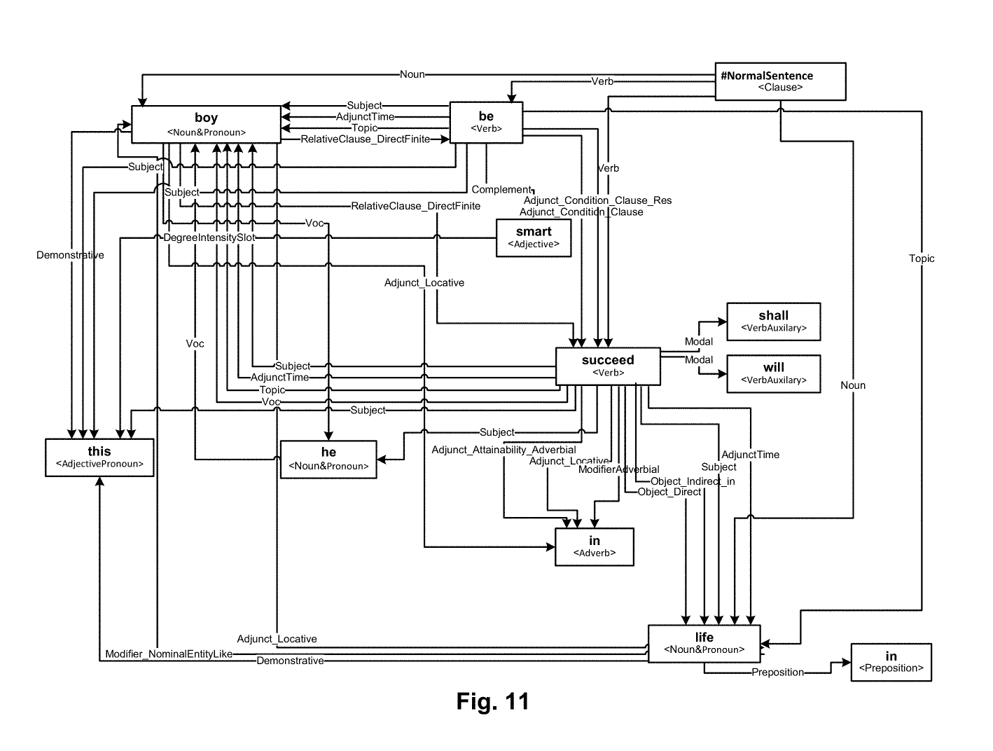

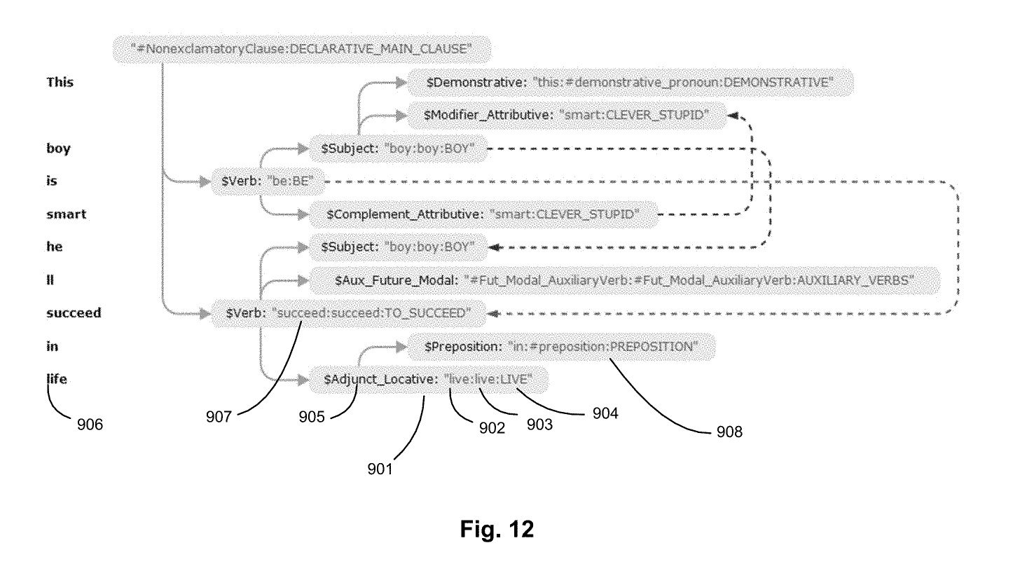

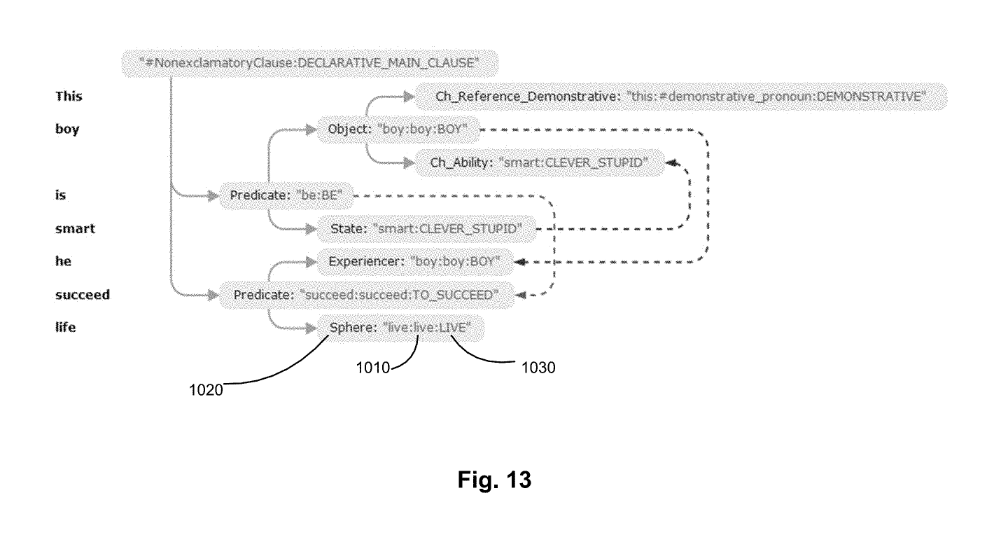

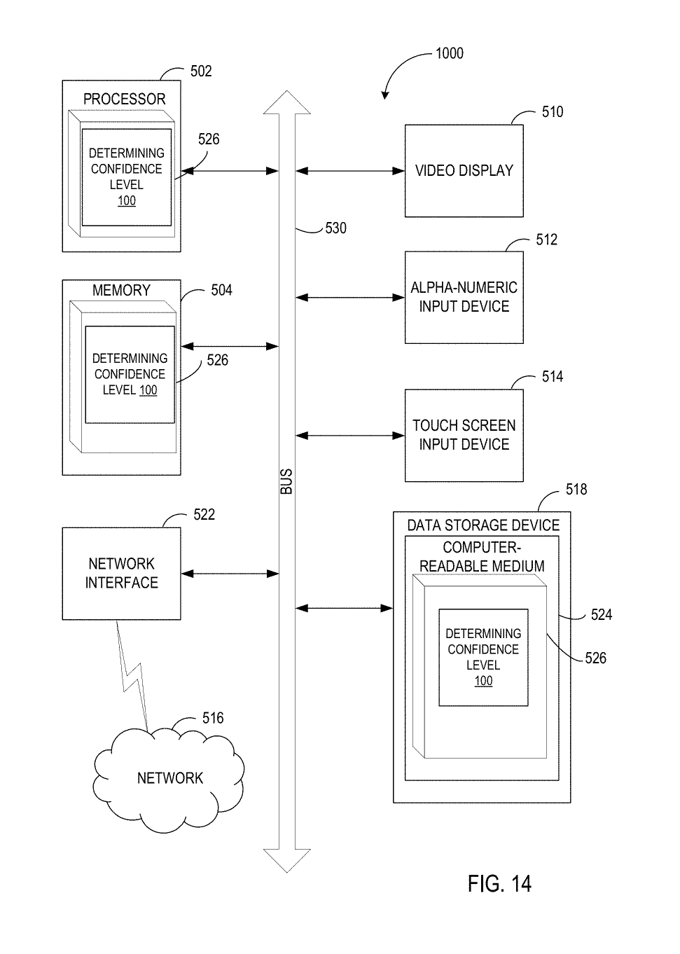

FIGS. 3-7 are flow diagrams of various implementations of methods related to text output command sequencing for documents. The methods are performed by processing logic that may include hardware (circuitry, dedicated logic, etc.), software (such as is run on a general purpose computer system or a dedicated machine), or a combination of both. The methods and/or each of their individual functions, routines, subroutines, or operations may be performed by one or more processors of a computing device (e.g., computing system 800 of FIG. 8) implementing the methods. In certain implementations, the methods may be performed by a single processing thread. Alternatively, the methods may be performed by two or more processing threads, each thread implementing one or more individual functions, routines, subroutines, or operations of the methods. Some methods may be performed by text output command sequencing module 130 of FIG. 1.

For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

FIG. 3 depicts a flow diagram of an example method 300 for smart text output command sequencing. At block 305 of method 300, processing logic receives a document comprising a plurality of text output commands in a text layer of the document. In some implementations, each text output command is to render one or more glyphs on a display device. At block 310, processing logic identifies, using the plurality of text output commands in the text layer, as set of text output commands for a page of a plurality of pages of the document.

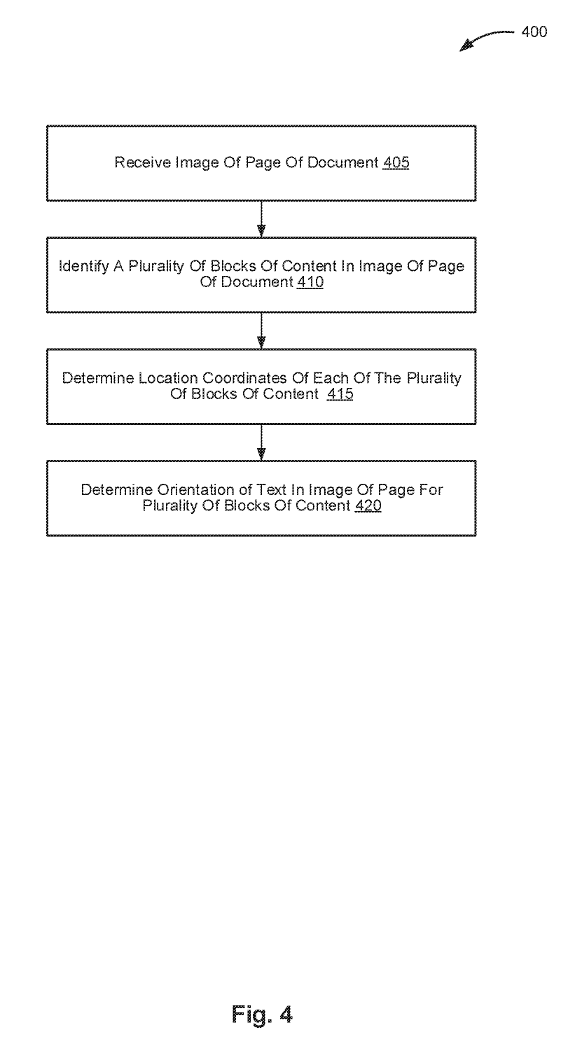

At block 315, processing logic determines a logical structure of the page of the document. In some implementations, the logical structure of the page comprises a plurality of blocks of content that cause an order of the set of text output commands in the text layer to differ from a reading order of the page. In an illustrative example, processing logic may determine the logical structure as described below with respect to FIG. 4.

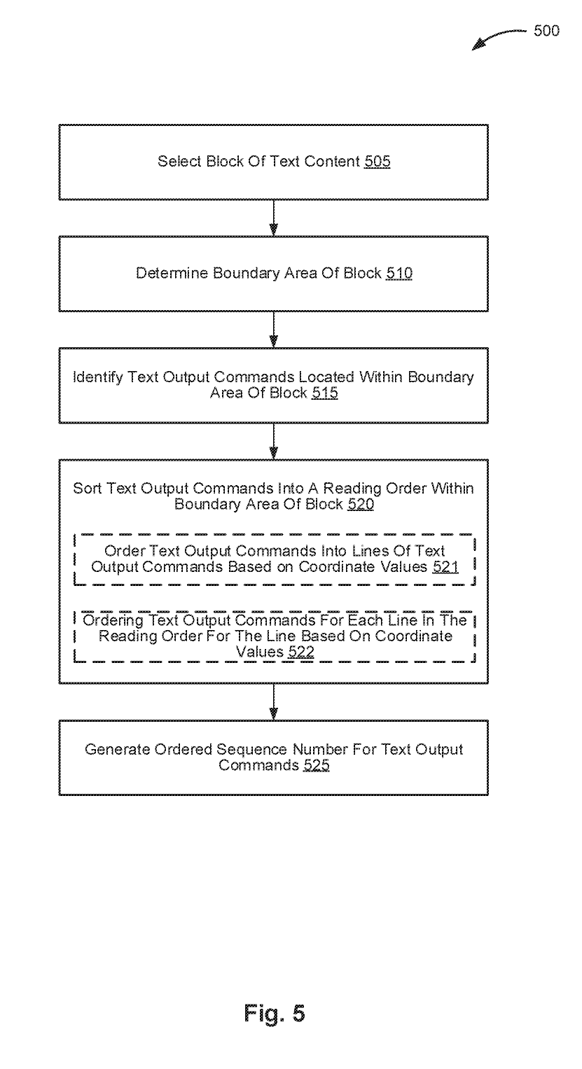

At block 320, processing logic determines an ordered sequence of the set of text output commands for the page, where the ordered sequence reflects the reading order within each of the plurality of blocks of content. In an illustrative example, processing logic may determine the ordered sequence as described below with respect to FIG. 5

At block 325, processing logic generates a modified text layer for the document, where the modified text layer comprises the set of text output commands in the ordered sequence. At block 330, processing logic provides the modified text layer to cause the display device to render a plurality of glyphs corresponding to the set of text output commands in the ordered sequence. After block 330, the method of FIG. 3 terminates.

FIG. 4 depicts a flow diagram of an example method 400 for determining the logical structure of a page of a document. At block 405 of method 400, processing logic receives an image of a page of the document. At block 410, processing logic identifies a plurality of blocks of content in the image of the page of the document. At block 415, processing logic determines location coordinates of each of the plurality of blocks of content in the image of the page of the document. At block 420, processing logic determines an orientation of text in the image for the plurality of blocks of content. After block 420, the method of FIG. 4 terminates.

FIG. 5 depicts a flow diagram of an example method 500 for determining an ordered sequence of text output commands for a page of a document. At block 505 of method 500, processing logic selects a block of content in the page, where the block of content comprises text content. At block 510, processing logic determines a boundary area of the block of content based on the location coordinates of the block of content. At block 515, processing logic identifies a subset of text output commands located within the boundary area of the first block.

At block 520, processing logic sorts the subset of text output commands into a reading order within the boundary area of the block of content. In some implementations, processing logic orders the subset of text output commands in to lines of text output commands based on coordinate values of the subset of output commands (521). Processing logic may then order the text output commands for each of the lines of text output commands in the reading order within the boundary area of the block of content based on the coordinate values (522).

At block 525, processing logic generates an ordered sequence number for each text output command of the subset of text output commands, where each ordered sequence number reflects the position of the corresponding text output command in the reading order for the block of content. After block 525, the method of FIG. 5 terminates.

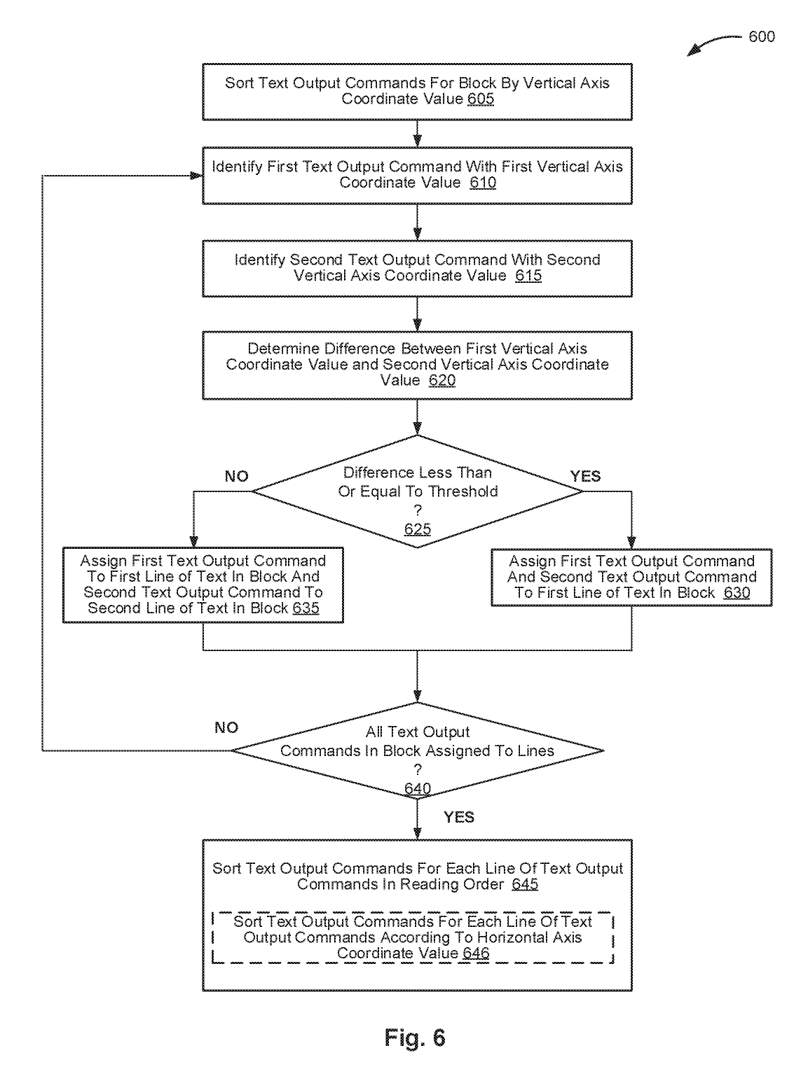

FIG. 6 depicts a flow diagram of an example method 600 for sorting text output commands into reading order for horizontal text. At block 605 of method 600, processing logic sorts a subset of text output commands by vertical axis coordinate value. At block 610, processing logic identifies a first text output command with a first vertical axis coordinate value. At block 615, processing logic identifies a second text output command with a second vertical axis coordinate value. At block 620, processing logic determines the difference between the first vertical axis coordinate value and the second vertical axis coordinate value.

At block 625, processing logic branches based on the difference between the first vertical axis coordinate value and the second vertical axis coordinate value. If the difference is less than or equal to a threshold value, processing logic continues to block 630. Otherwise, processing logic proceeds to block 635. At block 630, processing logic assigns the first text output command and the second text output command to a first line of text in the block. At block 635, processing logic assigns the first text output command to a first line of text in the block and the second text output command to a second line of text in the block.

In some implementations, blocks 610 through 635 may be repeated for each pair of the text output commands in the block of text sorted by vertical axis coordinate. At block 640, processing logic determines whether all of the text output commands in the block have been assigned to lines of text output commands in the block. If not, processing logic returns to block 610 to identify the next text output command in the block and assign it to a line of text output commands for the block based on the coordinates of that next text output command.

After each of the sorted text output commands have been assigned to a line of text in the block of text, processing logic proceeds to block 645. At block 645, processing logic sorts the text output commands for each line of text output commands in reading order. In some implementations, block 646 may be invoked to sort the text output commands for each line of text output commands according to the horizontal axis coordinate values of text output commands in the line. After block 645 (or block 646), the method of FIG. 6 terminates.

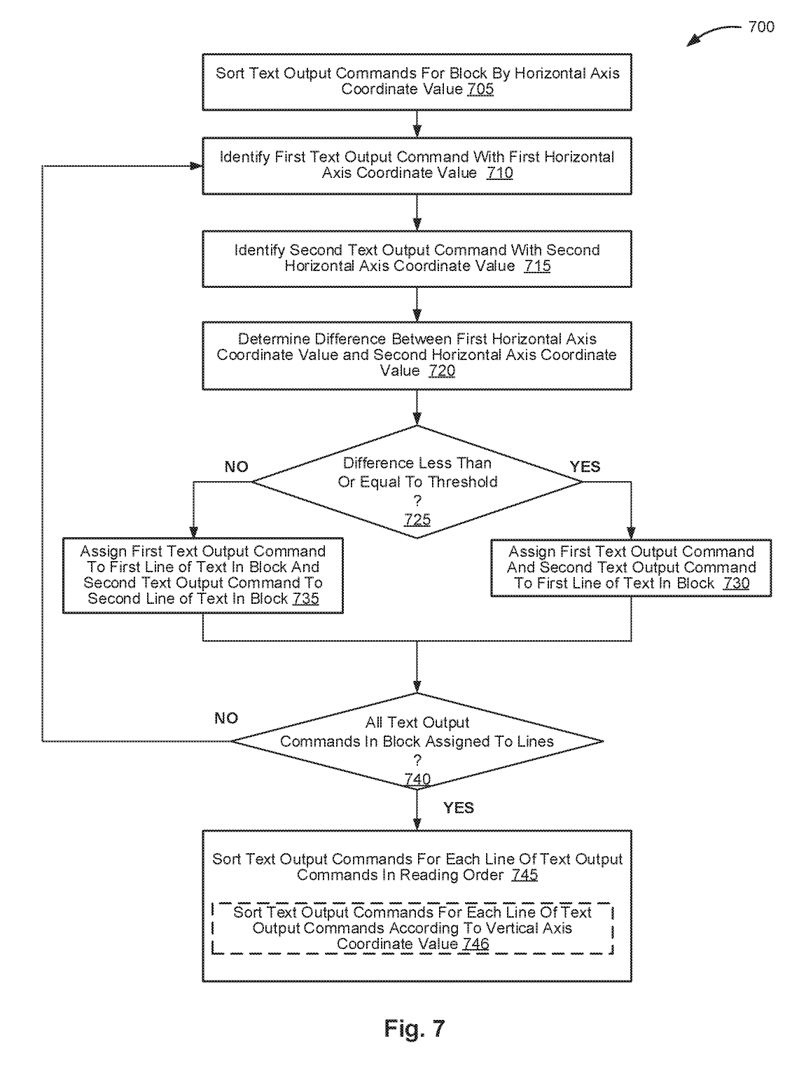

FIG. 7 depicts a flow diagram of an example method 700 for sorting text output commands into reading order for vertical text. At block 705 of method 700, processing logic sorts a subset of text output commands by horizontal axis coordinate value. At block 710, processing logic identifies a first text output command with a first horizontal axis coordinate value. At block 715, processing logic identifies a second text output command with a second horizontal axis coordinate value. At block 720, processing logic determines the difference between the first horizontal axis coordinate value and the second horizontal axis coordinate value.

At block 725, processing logic branches based on the difference between the first horizontal axis coordinate value and the second horizontal axis coordinate value. If the difference is less than or equal to a threshold value, processing logic continues to block 730. Otherwise, processing logic proceeds to block 735. At block 730, processing logic assigns the first text output command and the second text output command to a first line of text in the block. At block 735, processing logic assigns the first text output command to a first line of text in the block and the second text output command to a second line of text in the block.

In some implementations, blocks 710 through 735 may be repeated for each pair of the text output commands in the block of text sorted by horizontal axis coordinate. At block 740, processing logic determines whether all of the text output commands in the block have been assigned to lines of text output commands in the block. If not, processing logic returns to block 710 to identify the next text output command in the block and assign it to a line of text output commands for the block based on the coordinates of that next text output command.

After each of the sorted text output commands have been assigned to a line of text in the block of text, processing logic proceeds to block 745. At block 745, processing logic sorts the text output commands for each line of text output commands in reading order. In some implementations, block 746 may be invoked to sort the text output commands for each line of text output commands according to the vertical axis coordinate values of text output commands in the line. After block 745 (or block 746), the method of FIG. 7 terminates.

FIG. 8 depicts an example computer system 800 which can perform any one or more of the methods described herein. In one example, computer system 800 may correspond to a computing device capable of executing text output command sequencing module 130 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 800 includes a processing device 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 816, which communicate with each other via a bus 808.

Processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute text output command sequencing module 826 for performing the operations and steps discussed herein (e.g., corresponding to the methods of FIGS. 3-7, etc.).

The computer system 800 may further include a network interface device 822. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 820 (e.g., a speaker). In one illustrative example, the video display unit 810, the alphanumeric input device 812, and the cursor control device 814 may be combined into a single component or device (e.g., an LCD touch screen).

The data storage device 816 may include a computer-readable medium 824 on which is stored text output command sequencing module 826 (e.g., corresponding to the methods of FIGS. 3-7, etc.) embodying any one or more of the methodologies or functions described herein. Text output command sequencing module 826 may also reside, completely or at least partially, within the main memory 804 and/or within the processing device 802 during execution thereof by the computer system 800, the main memory 804 and the processing device 802 also constituting computer-readable media. Text output command sequencing module 826 may further be transmitted or received over a network via the network interface device 822.

While the computer-readable storage medium 824 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “identifying,” “determining,” “generating,” “providing,” “storing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

1. A method comprising:
receiving, by a processing device, a document comprising a plurality of text output commands in a text layer, wherein each text output command is to render one or more glyphs on a display device;
identifying, using the plurality of text output commands in the text layer, a set of text output commands for a page of a plurality of pages of the document;
determining a logical structure of the page of the document, wherein the logical structure of the page comprises a plurality of blocks of content that cause an order of the set of text output commands in the text layer to differ from a reading order of the page;
determining an orientation of text in the plurality of blocks of content;
determining, by the processing device, an ordered sequence of the set of text output commands for the page based on the orientation of text, wherein the ordered sequence reflects the reading order within each of the plurality of blocks of content;
generating, by the processing device, a modified text layer for the document, wherein the modified text layer comprises the set of text output commands in the ordered sequence; and
providing, by the processing device, the modified text layer to cause the display device to render a plurality of glyphs corresponding to the set of text output commands in the ordered sequence.

2. The method of claim 1, further comprising:
storing a modified document with the modified text layer.

3. The method of claim 1, wherein determining the logical structure of the page of the document comprises:
receiving an image of the page of the document;
identifying the plurality of blocks of content in the image of the page of the document; and
determining location coordinates of each of the plurality of blocks of content in the image of the page.

4. The method of claim 3, wherein determining the ordered sequence comprises:
selecting a first block of the plurality of blocks of content, wherein the first block comprises text content;
determining a boundary area of the first block based on the location coordinates of the first block;
identifying a first subset of text output commands located within the boundary area of the first block;
sorting the first subset of text output commands into a first reading order of the text commands within the boundary area of the first block; and
generating an ordered sequence number for each text output command of the first subset of text output commands, wherein each ordered sequence number reflects a position of a corresponding text output command in the first reading order.

5. The method of claim 4, wherein sorting the first subset of output commands comprises:
ordering the first subset of text output commands into a plurality of lines of text output commands based on coordinate values of the first subset of output commands; and
ordering the text output commands for each of the plurality of lines of text output commands in the reading order for the respective line based on the coordinate values.

6. The method of claim 5, wherein the orientation of text in the first block is horizontal, and wherein ordering the first subset of text output commands into lines comprises:
sorting the first subset of text output commands by vertical axis coordinate value;
identifying a first text output command of the first subset of text output commands with a first vertical axis coordinate value;
identifying a second text output command of the first subset of text output commands with a second vertical axis coordinate value; and
responsive to determining that a difference between the first vertical axis coordinate value and the second vertical axis coordinate value is less than or equal to a predetermined threshold, assigning the first text output command and the second text output command to a first line of text; and
responsive to determining that the difference between the first vertical axis coordinate and the second vertical axis coordinate is greater than a predetermined threshold, assigning the first text output command to the first line of text and the second text output command to a second line of text.

7. The method of claim 6, wherein ordering the text output commands for each line of text output commands in the reading order comprises:
sorting the text output commands for each line of text output commands in reading order.

8. The method of claim 7, further comprising:
sorting the text output commands for each line of text output commands in ascending order according to a corresponding horizontal coordinate value

9. The method of claim 5, wherein the orientation of text in the first block is vertical, and wherein ordering the first subset of text output commands into lines comprises:
sorting the first subset of text output commands in by horizontal axis coordinate value;
identifying a first text output command of the first subset of text output commands with a first horizontal axis coordinate value;
identifying a second text output command of the first subset of text output commands with a second horizontal axis coordinate value; and
responsive to determining that a difference between the first horizontal axis coordinate value and the second horizontal axis coordinate value is less than or equal to a predetermined threshold, assigning the first text output command and the second text output command to a first line of text; and
responsive to determining that the difference between the first horizontal axis coordinate and the second horizontal axis coordinate is greater than a predetermined threshold, assigning the first text output command to the first line of text and the second text output command to a second line of text.

10. The method of claim 9, wherein ordering the text output commands for each line of text output commands in the reading order comprises:
sorting the text output commands for each line of text output commands in reading order.

11. The method of claim 10, further comprising:
sorting the text output commands for each line of text output commands in ascending order according to a corresponding vertical coordinate value

12. The method of claim 4, further comprising:
selecting a second block of the plurality of blocks of content, wherein the second block comprises text content;
determining a boundary area of the second block based on the location coordinates of the second block;
identifying a second subset of text output commands located within the boundary area of the second block;
sorting the second subset of text output commands into a second reading order of the text commands within the boundary area of the second block; and
generating an additional ordered sequence number for each text output command of the second subset of text output commands, wherein each additional ordered sequence number reflects the position in the second reading order of the corresponding text output command of the second subset of text output commands.

13. The method of claim 10, wherein the ordered sequence numbers for the first subset of text output commands precede the additional ordered sequence numbers of the second subset of text output commands in the ordered sequence.

14. The method of claim 1, wherein the document comprises a portable document format (PDF) document.

15. The method of claim 1, wherein the plurality of blocks of content comprise at least one of a block of text content, a block of image content, or a block of tabular content.

16. A computing apparatus comprising:
a memory to store instructions; and
a processing device, operatively coupled to the memory, to execute the instructions, wherein the processing device is to:
receive, by the processing device, a document comprising a plurality of text output commands in a text layer, wherein each text output command is to render one or more glyphs on a display device;
identify, using the plurality of text output commands in the text layer, a set of text output commands for a page of a plurality of pages of the document;
determine a logical structure of the page of the document, wherein the logical structure of the page comprises a plurality of blocks of content that cause an order of the set of text output commands in the text layer to differ from a reading order of the page;
determine an orientation of text in the plurality of blocks of content;
determine, by the processing device, an ordered sequence of the set of text output commands for the page based on the orientation of text, wherein the ordered sequence reflects the reading order within each of the plurality of blocks of content;
generate, by the processing device, a modified text layer for the document, wherein the modified text layer comprises the set of text output commands in the ordered sequence; and
provide, by the processing device, the modified text layer to cause the display device to render a plurality of glyphs corresponding to the set of text output commands in the ordered sequence.

17. The computing apparatus of claim 16, wherein the processing device is further to:
store a modified document with the modified text layer.

18. The computing apparatus of claim 16, wherein to determine the logical structure of the page of the document, the processing device is to:
receive an image of the page of the document;
identify the plurality of blocks of content in the image of the page of the document; and
determine location coordinates of each of the plurality of blocks of content in the image of the page.

19. The computing apparatus of claim 18, wherein to determine the ordered sequence the processing device is to:
select a first block of the plurality of blocks of content, wherein the first block comprises text content;
determine a boundary area of the first block based on the location coordinates of the first block;
identify a first subset of text output commands located within the boundary area of the first block;
sort the first subset of text output commands into a first reading order of the text commands within the boundary area of the first block; and
generate an ordered sequence number for each text output command of the first subset of text output commands, wherein each ordered sequence number reflects a position of a corresponding text output command in the first reading order.

20. The computing apparatus of claim 19, wherein to sort the first subset of output commands, the processing device is to:
order the first subset of text output commands into a plurality of lines of text output commands based on coordinate values of the first subset of output commands; and
order the text output commands for each of the plurality of lines of text output commands in the reading order for the respective line based on the coordinate values.

21. The computing apparatus of claim 20, wherein the orientation of the text in the first block is horizontal, and wherein to order the first subset of output commands into lines, the processing device is to:
sort the first subset of text output commands by vertical axis coordinate value;
identify a first text output command of the first subset of text output commands with a first vertical axis coordinate value;
identify a second text output command of the first subset of text output commands with a second vertical axis coordinate value; and
responsive to determining that a difference between the first vertical axis coordinate value and the second vertical axis coordinate value is less than or equal to a predetermined threshold, assign the first text output command and the second text output command to a first line of text; and
responsive to determining that the difference between the first vertical axis coordinate and the second vertical axis coordinate is greater than a predetermined threshold, assign the first text output command to the first line of text and the second text output command to a second line of text.

22. The computing apparatus of claim 21, wherein to order the text output commands for each line of text output commands in the reading order, the processing device is to:
sort the text output commands for each line of text output commands in reading order.

23. The computing apparatus of claim 22, further comprising:
sort the text output commands for each line of text output commands in ascending order according to a corresponding horizontal coordinate value

24. The computing apparatus of claim 20, wherein the orientation of text in the first block is vertical, and wherein to order the first subset of text output commands into lines, the processing device is to:
sort the first subset of text output commands in by horizontal axis coordinate value;
identify a first text output command of the first subset of text output commands with a first horizontal axis coordinate value;
identify a second text output command of the first subset of text output commands with a second horizontal axis coordinate value; and
responsive to determining that a difference between the first horizontal axis coordinate value and the second horizontal axis coordinate value is less than or equal to a predetermined threshold, assign the first text output command and the second text output command to a first line of text; and
responsive to determining that the difference between the first horizontal axis coordinate and the second horizontal axis coordinate is greater than a predetermined threshold, assign the first text output command to the first line of text and the second text output command to a second line of text.

25. The computing apparatus of claim 24, wherein to order the text output commands for each line of text output commands in the reading order, the processing device is to:
sort the text output commands for each line of text output commands in reading order.

26. The computing apparatus of claim 25, further comprising:
sort the text output commands for each line of text output commands in ascending order according to a corresponding vertical coordinate value

27. The computing apparatus of claim 19, wherein the processing device is further to:
select a second block of the plurality of blocks of content, wherein the second block comprises text content;
determine a boundary area of the second block based on the location coordinates of the second block;
identify a second subset of text output commands located within the boundary area of the second block;
sort the second subset of text output commands into a second reading order of the text commands within the boundary area of the second block; and
generate an additional ordered sequence number for each text output command of the second subset of text output commands, wherein each additional ordered sequence number reflects the position in the second reading order of the corresponding text output command of the second subset of text output commands.

28. The computing apparatus of claim 27, wherein the ordered sequence numbers for the first subset of text output commands precede the additional ordered sequence numbers of the second subset of text output commands in the ordered sequence.

29. The computing apparatus of claim 16, wherein the document comprises a portable document format (PDF) document.

30. The computing apparatus of claim 16, wherein the plurality of blocks of content comprise at least one of a block of text content, a block of image content, or a block of tabular content.

31. A non-transitory computer readable storage medium, having instructions stored therein, which when executed by a processing device of a computer system, cause the processing device to perform operations comprising:
receiving, by the processing device, a document comprising a plurality of text output commands in a text layer, wherein each text output command is to render one or more glyphs on a display device;
identifying, using the plurality of text output commands in the text layer, a set of text output commands for a page of a plurality of pages of the document;
determining a logical structure of the page of the document, wherein the logical structure of the page comprises a plurality of blocks of content that cause an order of the set of text output commands in the text layer to differ from a reading order of the page;
determining an orientation of text in the plurality of blocks of content;
determining, by the processing device, an ordered sequence of the set of text output commands for the page based on the orientation of text, wherein the ordered sequence reflects the reading order within each of the plurality of blocks of content;
generating, by the processing device, a modified text layer for the document, wherein the modified text layer comprises the set of text output commands in the ordered sequence; and
providing, by the processing device, the modified text layer to cause the display device to render a plurality of glyphs corresponding to the set of text output commands in the ordered sequence.

32. The non-transitory computer readable storage medium of claim 31, the operations further comprising:
storing a modified document with the modified text layer.

33. The non-transitory computer readable storage medium of claim 31, wherein determining the logical structure of the page of the document comprises:
receiving an image of the page of the document;
identifying the plurality of blocks of content in the image of the page of the document; and
determining location coordinates of each of the plurality of blocks of content in the image of the page.

34. The non-transitory computer readable storage medium of claim 33, wherein determining the ordered sequence comprises:
selecting a first block of the plurality of blocks of content, wherein the first block comprises text content;
determining a boundary area of the first block based on the location coordinates of the first block;
identifying a first subset of text output commands located within the boundary area of the first block;
sorting the first subset of text output commands into a first reading order of the text commands within the boundary area of the first block; and
generating an ordered sequence number for each text output command of the first subset of text output commands, wherein each ordered sequence number reflects a position of a corresponding text output command in the first reading order.

35. The non-transitory computer readable storage medium of claim 34, wherein sorting the first subset of output commands comprises:
ordering the first subset of text output commands into a plurality of lines of text output commands based on coordinate values of the first subset of output commands; and
ordering the text output commands for each of the plurality of lines of text output commands in the reading order for the respective line based on the coordinate values.

36. The non-transitory computer readable storage medium of claim 35, wherein the orientation of text in the first block is horizontal, and wherein ordering the first subset of text output commands into lines comprises:
sorting the first subset of text output commands by vertical axis coordinate value;
identifying a first text output command of the first subset of text output commands with a first vertical axis coordinate value;
identifying a second text output command of the first subset of text output commands with a second vertical axis coordinate value; and
responsive to determining that a difference between the first vertical axis coordinate value and the second vertical axis coordinate value is less than or equal to a predetermined threshold, assigning the first text output command and the second text output command to a first line of text; and
responsive to determining that the difference between the first vertical axis coordinate and the second vertical axis coordinate is greater than a predetermined threshold, assigning the first text output command to the first line of text and the second text output command to a second line of text.

37. The non-transitory computer readable storage medium of claim 36, wherein ordering the text output commands for each line of text output commands in the reading order comprises:
sorting the text output commands for each line of text output commands in reading order.

38. The non-transitory computer readable storage medium of claim 37, further comprising:
sorting the text output commands for each line of text output commands in ascending order according to a corresponding horizontal coordinate value

39. The non-transitory computer readable storage medium of claim 35, wherein the orientation of text in the first block is vertical, and wherein ordering the first subset of text output commands into lines comprises:
sorting the first subset of text output commands in by horizontal axis coordinate value;
identifying a first text output command of the first subset of text output commands with a first horizontal axis coordinate value;
identifying a second text output command of the first subset of text output commands with a second horizontal axis coordinate value; and
responsive to determining that a difference between the first horizontal axis coordinate value and the second horizontal axis coordinate value is less than or equal to a predetermined threshold, assigning the first text output command and the second text output command to a first line of text; and
responsive to determining that the difference between the first horizontal axis coordinate and the second horizontal axis coordinate is greater than a predetermined threshold, assigning the first text output command to the first line of text and the second text output command to a second line of text.

40. The non-transitory computer readable storage medium of claim 39, wherein ordering the text output commands for each line of text output commands in the reading order comprises:
sorting the text output commands for each line of text output commands in reading order.

41. The non-transitory computer readable storage medium of claim 40, further comprising:
sorting the text output commands for each line of text output commands in ascending order according to a corresponding vertical coordinate value

42. The non-transitory computer readable storage medium of claim 34, the operations further comprising:
selecting a second block of the plurality of blocks of content, wherein the second block comprises text content;
determining a boundary area of the second block based on the location coordinates of the second block;
identifying a second subset of text output commands located within the boundary area of the second block;
sorting the second subset of text output commands into a second reading order of the text commands within the boundary area of the second block; and
generating an additional ordered sequence number for each text output command of the second subset of text output commands, wherein each additional ordered sequence number reflects the position in the second reading order of the corresponding text output command of the second subset of text output commands.

43. The non-transitory computer readable storage medium of claim 31, wherein the ordered sequence numbers for the first subset of text output commands precede the additional ordered sequence numbers of the second subset of text output commands in the ordered sequence.

44. The non-transitory computer readable storage medium of claim 31, wherein the document comprises a portable document format (PDF) document.

45. The non-transitory computer readable storage medium of claim 31, wherein the plurality of blocks of content comprise at least one of a block of text content, a block of image content, or a block of tabular content.
